(19) United States
(12) Patent Application Publication
(10) Pub. No.: US 2008/0038417 A1
(43) Pub. Date: Feb. 14, 2008

(54) Method of Preparing Cuts of Meat

(75) Inventors: Roger Keith Palmer, Katikati (NZ); Clyde Charles Daly, Cambridge (NZ)

Correspondence Address: BIRCH STEWART KOLASCH & BIRCH, PO BOX 747, FALLS CHURCH, VA, 22040-0747, US

(73) Assignee: FOODCAP INTERNATIONAL LIMITED, Auckland (NZ)

(21) Appl. No.: 11/665,388

(22) PCT Filed: Oct. 14, 2005
(86) PCT No.: PCT/NZ05/00269

§ 371 Date: Oct. 4, 2007

(30) Foreign Application Priority Data
Oct. 15, 2004 (NZ) NZ 536008

(51) Int. Cl. A23L 1/272; A23L 1/31

(52) U.S. Cl. 426/264; 426/647

(57) ABSTRACT

A method of maintaining a desirable fresh and/or healthy appearance of a cut of meat during retail display including the steps of maintaining said cut of meat at a temperature within a temperature range as close to freezing as possible without freezing said meat following cutting of said meat from a meat primal; and maintaining said meat at said temperature in an oxygenated environment for a predetermined extended period of time before transfer to a retail display temperature.

### TECHNICAL FIELD OF THE INVENTION

The invention relates to a method of preparing a cut of meat and in particular to a method of maintaining a desirable fresh and/or healthy appearance of a cut of meat during retail display thereby extending retail shelf life. The invention has special, although not exclusive, application in centralised processing systems that supply remote retail outlets with their requirements for meat products ready for retail sale and is described hereafter with reference to this application. It will be appreciated that the invention may also have application to other fields.

Throughout this specification it is to be understood that references to “meat” include all forms of meat of all descriptions generally considered to be edible, having myoglobin, and including fish, beef, lamb, poultry and offal for example.

### BACKGROUND TO THE INVENTION

Traditionally, meat has been considered to have a relatively short retail shelf life. A familiar healthy bloom such as red/pink colour which connotes freshness of, for example, beef or lamb, to many consumers is difficult to maintain and it is not long before a fresh surface of a cut of meat dteriorates to a brown or other “off” colour associated by consumers with “old meat”. Historically, supermarkets or specialist fresh meat retailers have carried out meat preparation operations in a butchery at or adjacent to the retail sales area.

A perceived relatively short shelf life after retail preparation has been considered a barrier to the uptake of more centralised forms of meat preparation. Meat preparation for retail sale often encompasses the preparation of intact muscle cuts, cubed, stripped and ground meat into suitably sized portions for retail sale. Delay between the time when a surface of meat is first exposed to air in preparing the meat for retail sale and presenting the meat to the consumer in retail display packs is believed to subtract from the total retail shelf life of the product. Obviously any meat prepared for retail sale and not sold, as a result of losing its attractive, healthy and fresh appearance is inefficient and adds to cost in the overall sales chain.

Colour transformation in meat is believed to be principally associated with chemical changes in the main meat pigment, myoglobin. Myoglobin binds with oxygen and is responsible for transporting oxygen within muscle cells. When it does this, myoglobin changes in colour from a dark purple to a bright red (oxymyoglobin). The healthy and/or fresh appearance of meat for retail sale is associated with myoglobin binding to oxygen in an oxygen environment.

Myoglobin can also undergo a less desirable reaction in meat following exposure to oxygen. The iron (Fe) atom in the centre of the molecule oxidises from Fe⁺² to Fe⁺³ to convert the myoglobin to metmyoglobin which has a brown colour. This reaction causing browning of meat indicates to most consumers the meat is “past its best” and possibly even in early stages of putrefaction. In terms of retail meat display, it is, of course, desirable to inhibit or delay myoglobin oxidisation to metmyoglobin and/or the visible effect of myoglobin oxidisation for as long as possible.

The rate at which meat myoglobin oxidises to metmyoglobin is predominantly influenced by the proportion of myoglobin in the oxymyoglobin form. The rate of metmyoglobin formation is greatest when a small proportion of myoglobin is in the oxymyoglobin form and least when all the myoglobin is in the oxymyoglobin form (without the presence of oxygen, metmyoglobin does not form). At a cut surface of meat prepared for retail display, myoglobin is primarily in an oxymyoglobin form as a result of exposure to oxygen.

However, within the deeper layers of the meat a lower proportion of myoglobin is in the oxymyoglobin state and metmyoglobin forms more quickly. These changes are not necessarily immediately visible on the meat surface, however over time, metmyoglobin formation extends toward the more oxygenated surface layers, rendering visible an unattractive brown appearance to such meat which is then regarded as unsaleable.

Prior art systems have been developed to delay visible meat browning with the intention of extending meat shelf-life. These include master pack systems; reduced oxygen packaging; modified atmosphere packaging (low-oxygen/high carbon dioxide or high-oxygen/high carbon dioxide); and multi-stage or composite systems. These systems will be known to those skilled in the art but are not without cost and complication.

Interest has primarily focused on the modified atmosphere packaging systems. “High oxygen modified atmosphere packs” (HiOx) attempt to provide meat colour stability by packaging a meat sample in a high oxygen atmosphere, typically 80% (increased from ambient 20% concentration). The remaining 20% atmosphere is usually carbon dioxide to reduce microbial growth.

To maintain the modified atmosphere, the packaging system must be fully sealed and contain enough “head space” to compensate for meat absorption and consumption of components of the modified atmosphere gases. HiOx packing is relatively expensive, as is the equipment used to implement it. The head space required within the pack to maintain the appropriate atmosphere is bulky for storage, handling and transport. Exposure of meat to high oxygen atmospheres has been found to have an adverse effect on the meat. Typically it can produce rancid flavours and render identification of cooking temperatures based on cooked meat colour unreliable for the end user.

An alternative to using high oxygen atmospheres in sealed retail packs is the use of is carbon monoxide (CO). This gas consists of, typically, 0.4% CO, with the remainder either CO₂ or a CO₂/N₂ mix. CO binds to myoglobin to form carboxymyoglobin which has a bright red colour. While the CO is bound to myoglobin, the myoglobin resists the formation of metmyoglobin and essentially resists metmyoglobin browning.

The use of CO in modified atmosphere systems has a number of disadvantages. Particularly CO-containing modified atmosphere retail packs can maintain an attractive red colour in the meat long after it has become microbiologically unsafe. From a consumer appeal point of view, CO treatment is also considered commercially questionable given that CO is well known in the community to be toxic.

An alternative to modified atmosphere retail packs involves the use of a modified atmosphere “motherbag” during transport to the retail outlet. A collection of gas permeable overwrap retail packs are placed into a plastic motherbag and the atmosphere within the bag is replaced with a modified atmosphere. The retail packs are exposed to air only once they are ready to be displayed in the retail display cabinet.

The modified atmosphere in the motherbag is provided in an attempt to delay discolouration during transit, retail display life is, however, not increased compared with in-store preparation. As soon as the atmosphere returns to a standard or ambient atmosphere and the motherbag gases disperse, the decay process reverts to the same pathway as is seen in meat that is held in atmospheric conditions throughout.

Three forms of modified atmospheres are commonly used in the motherbag system: high oxygen (typically 80% oxygen, 20% carbon dioxide), no oxygen (100% carbon dioxide, CO₂) and CO.

High oxygen (80% oxygen) motherbag atmospheres maintain colour stability during transit. However, the colour stability is maintained for, at best, an additional week. Furthermore, the motherbag takes up room and can be easily punctured, allowing oxygen entry into the motherbag and subsequent browning of the meat. The discarded motherbags also result in waste material which can be difficult to dispose of.

CO₂ (no oxygen) motherbags are promoted as delaying degradation of meat colour by excluding exposure to oxygen as soon as possible after retail pack preparation and throughout the subsequent transport phase. However, it has been found that residual oxygen left in the motherbag after flushing can cause meat surface browning. To resist this, a chemical oxygen scavenger is sometimes included in the motherbag to help remove residual levels of oxygen. These chemicals are at least commercially undesirable.

Ineffective removal of atmospheric oxygen can trigger severe browning of the meat. Motherbags need to be inflated with an excess of CO₂ to create sufficient volume to account for transportation time. CO₂ can also increase the rate of fluid release or exudation from meat. The red exudate (drip) is, understandably, not well received by consumers when visible and can make the meat look flaccid even when the exudate is scavenged by the use of absorbent pads.

Recent interest has focused on CO motherbag systems. While the CO is present in the motherbag, meat colour is maintained in the red carboxymyoglobin form. However, CO dissociates from the meat when the retail pack is returned to a normal atmosphere. The shelf life of the meat during retail display is accordingly not significantly increased over conventional wrapped products. Customer resistance to the use of toxic CO is a problem.

### OBJECT OF THE INVENTION

It is an object of the invention to overcome or ameliorate at least one of the disadvantages of the prior art and/or to at least provide the public with a useful choice.

It is a further or alternative object of the invention to provide a method of maintaining a desirable fresh and/or healthy appearance of a cut of meat during retail display thereby extending shelf life.

### SUMMARY OF THE INVENTION

According to one aspect of this invention there is provided a method of maintaining a desirable fresh and/or healthy appearance of a cut of meat during retail display including the steps of:
maintaining said cut of meat at a temperature within a temperature range as close to freezing as possible without freezing said meat following cutting of said meat from a meat primal; and
maintaining said meat at said temperature in an oxygenated environment for a predetermined extended period of time before transfer to a retail display temperature.

Preferably, said cutting includes exposing normally substantially anaerobic regions of said meat primal to an oxygenated environment to create said cut of meat having new surfaces which are exposed for the first time.

Preferably, said cut of meat is maintained at said temperature in an oxygenated environment immediately after cutting.

Preferably, said oxygenated environment has an ambient or elevated oxygen level.

Preferably, said predetermined extended period of time is selected to increase the depth and/or penetration of oxygenation of exposed surfaces of said meat.

Preferably, said predetermined extended period of time is typically between about 7 hours to about 24 hours.

Preferably, said temperature range is between about freezing point of said meat and about 3° C.

Preferably, said meat is maintained at a temperature of substantially about −1.8° C. to 3° C.

Preferably the meat is maintained at a temperature of about −1.5° C.

Preferably, said meat primal is cooled before cutting.

Preferably, said meat primal is stored in a cooled substantially oxygen-free environment prior to cutting.

Preferably, said meat primal is stored under positive pressure prior to cutting.

Preferably, said positive pressure is applied by a mechanical process exerting at least 3 psi directly to said meat primal.

According to a further aspect of this invention there is provided a method of maintaining a desirable fresh and/or healthy appearance of a cut of meat during retail display including the steps of:
preconditioning by storage of a meat primal under positive pressure in a substantially oxygen-free environment while cooling and before cutting into said cut of meat; and
conditioning said cut of meat following cutting by maintaining said cut of meat at a temperature within a temperature range as close to freezing as possible without freezing said cut of meat following cutting in an oxygenated environment for a predetermined extended period of time before transfer to a retail display temperature.

Preferably, said cutting includes exposing normally substantially anaerobic regions of said meat primal to an oxygenated environment to create said cut of meat having new surfaces which are exposed for the first time.

Preferably, said cut of meat is maintained at said temperature in an oxygenated environment immediately following cutting.

Preferably, said positive pressure is applied by a mechanical process exerting at least 3 psi directly to said meat primal.

Preferably, said substantially oxygen-free environment is maintained by the exclusion of gases or without anoxic gases.

Preferably, said predetermined extended period of time selected for conditioning is relative to a required depth and/or penetration oxygenation below exposed surfaces of said cut of meat.

Preferably, said predetermined extended time period is within the range of 7 hours to 24 hours.

Preferably, said temperature range is between the temperature as close to freezing of the meat without freezing said meat and 3° C.

Preferably, said cut of meat is maintained at a temperature substantially about −1.8° C. to 3° C.

Preferably the cut of meat is maintained at a temperature of about −1.5° C.

According to a further aspect of this invention there is provided a method of stabilising meat colour in and below the surface of a cut of meat by suppressing myoglobin conversion to metmyoglobin at least on or immediately adjacent to the surface of said cut of meat.

Preferably, conversion is suppressed by suppressing oxygen consuming reactions in the meat, whilst said meat is exposed to an oxygenated environment.

According to a further aspect of this invention there is provided a meat product produced from the method(s) described above.

According to a further aspect of this invention there is provided a method of maintaining a desirable fresh and/or healthy appearance of a cut of meat substantially as herein described with reference to any one of the accompanying Figures.

According to a further aspect of this invention there is provided a meat product, substantially as herein described with reference to any one of the accompanying Figures.

### DESCRIPTION OF THE FIGURES

The invention will now be described by way of example and with reference to the Figures in which:

FIG. 1 illustrates the effect of temperature on oxygen consuming reactions (OCR) and metmyoglobin accumulation;

FIG. 2 illustrates the level of oxymyoglobin relative to depth for a cut of meat conditioned for different time periods;

FIG. 3 illustrates the reduction of OCR and increased depth of penetration of oxygenation on exposed surfaces of the cut of meat as conditioning time is increased; and

FIG. 4 illustrates a cross-section schematic view of a cut of meat and the delay of metmyoglobin appearance in such meat when conditioned relative to unconditional meat.

### DETAILED DESCRIPTION OF THE INVENTION

Throughout the specification, reference is made to “cut of meat”. Cutting is to be understood as the process of dividing meat primal portions of meat, typically removed from an animal carcass, into smaller portions (cuts of meat) including portions for retail sale and includes intact muscle cuts, cubed, stripped and ground meat. This, it will be appreciated exposes normally anaerobic regions of the meat primal to an oxygenated environment to create the cut of meat having new surfaces which are exposed for the first time. The resulting cuts of meat are commonly referred to in the field as “cabinet ready”. It will be appreciated that cutting will normally occur following cooling of the meat, post-slaughter, in accordance with normal practice.

Throughout the specification the term “meat primal” is also used. This term is intended to refer to meat prior to cutting. Typically, this will refer to meat which has been principally deboned, and could include muscle portions as well as large quantities of mince, for example.

Broadly the invention provides a method for maintaining a desirable fresh and/or healthy appearance of a cut of meat during retail display to extend shelf life.

Thus the present invention provides a method of maintaining a healthy and attractive appearance of a cut of meat for an extended period over traditional treatment without the need for modified atmosphere packing or other prior art systems. This is achieved through exploiting and/or manipulating natural processes operating within the cut of meat. Advantageously the present invention also provides a more natural and healthier alternative for maintaining a desirable fresh and/or healthy appearance of meat (bright red or pink) than is provided by prior art methods.

The term “fresh and/or healthy appearance” is intended to refer to the colour of meat which is attractive in the marketplace. A desirable fresh and/or healthy appearance is typically, for example in beef or lamb, a bright red or pink colour; in chicken or pork it may be a pink or non-greyed appearance.

It will be appreciated by a skilled person that the exact colour which is considered fresh and/or healthy will depend in part on the views of consumers of a particular marketplace. The particular colour which is considered fresh and/or healthy will also vary according to the animal from which the meat is derived. A fresh and/or healthy appearance of a venison portion will be generally darker red than lamb, chicken or fish, portions, for example.

The invention revolves around conditioning methodology following cutting of the cut of meat primal into cuts of meat. The conditioning step includes maintaining the cut of meat at a temperature within a temperature range as close to freezing as possible without freezing the meat following cutting of the meat from a meat primal, and maintaining the cut of meat in an oxygenated environment for a predetermined extended period of time before transfer to retail display temperature.

The invention will be described by way of example by reference to one or more preferred embodiments of the method and, for example in relation to meat derived from a meat primal sourced from a carcass in the traditional manner. The conditioning step of the present invention is incorporated in, or complementary to, current meat preparation methods.

Traditionally following slaughter, the meat carcass is cooled to reduce the temperature to a recommended temperature of less than 7° C. Temperatures can be reduced according to known techniques. Also, specific cooling strategies for recognised species are known and may be integrated into the present invention to cool the meat carcass according to the invention.

In the present embodiment, it is desirable to gradually cool the carcass and, later, meat primals, to a temperature as close to freezing without freezing the meat. Obviously, the exact temperature may vary between animals and quality of the meat. In the preferred embodiment the meat primal is gradually cooled to a temperature between freezing point of the meat and about 3° C. Freezing point of meat is normally about −1.8° C. Typically it is desirable to maintain the meat just above freezing point at about −1.5° C.

Cooling strategies adopted affect pH, meat quality, tenderness and colour of the eventual cut of meat irrespective of the conditioning step. It will be appreciated by those skilled in the art that post-slaughter before the meat enters rigor mortis, two processes can affect meat tenderization. These are the rate of pH decline and the rate of carcass or meat primal cooling. The appearance and colour of the meat are also affected by these rates.

For example, rapid cooling combined with slow pH decline slows tenderisation and can, at extremes, make meat tough, and also darken meat colour. Slow cooling combined with a rapid pH decline produces conditions that are unfavourable to protein stability and causes many proteins to lose their functional characteristics leading to poor eating quality and a higher level of exudate and poor colour stability. Those skilled in the art will be aware of methods of cooling the meat that will optimise tenderness without adversely altering pH and meat colour.

The meat carcass can be deboned into meat primal portions at any temperature. It is desirable from a handling point of view to debone the meat carcass once cooled to about 5° C., although hot deboning (when the carcass is boned without prior chilling) is also acceptable.

While deboning and meat retail preparation may take place at the same time, in the preferred embodiment the meat primals resulting from deboning are aged before retail preparation. The carcass is deboned and/or divided into manageable meat primal portions which are cooled preferably to −1.5° C. before retail preparation. This preferred treatment period between deboning and cutting is described in U.S. Pat. No. 6,194,012 and U.S. Pat. No. 5,670,195 but is not essential. It will be appreciated that it is not essential that the carcass be deboned and that the meat primal may be formed by slicing the carcass into manageable portions and/or partially deboned.

Retail preparation includes cutting the meat primal into retail cuts of meat which as a result expose normally substantially anaerobic regions of the meat primal to an oxygenated environment by creating the cuts of meat having new surfaces which are exposed for the first time. The size of the cuts of meat will vary according to the size of the portion to be delivered. In the preferred form, the meat is to be packaged into suitable retail containers for consumer sale, either as individual customer purchase packs or into so called “gourmet” packs for subsequent limited downstream breaking down for retail sale or in, for example, restaurant use.

To reduce contamination of meat or introduction of microorganisms, the meat is handled in hygienic plants and apparatus in a manner adapted to reduce as much as possible the introduction of microorganisms to the meat.

Handling and cutting of the primal meat into cuts of meat for retail sale is carried out in a low temperature working environment, preferably between −1.5° C. to 10° C., and more preferably under 6° C. with the meat-exposed for as short a time as possible to any temperatures above the lowest level. It is desirable to maintain the temperature of the working environment as close as possible to −1.5° C. However, this temperature may be too cold for staff to work comfortably or for equipment to operate without ice formation. Ideally, therefore, a working temperature of about 2° C. is appropriate. For optimum results, it is desirable that during retail preparation the majority of the meat remains as close to freezing as possible without freezing the meat. In the preferred form cutting is achieved with the bulk of the meat being kept substantially at the lower level temperatures, however some exposed surface may increase in temperature for a short period until the end of the cutting and subsequent packing.

Once retail preparation is complete the meat undergoes a conditioning step. The conditioning step includes maintaining the cut of meat at or around a temperature of about −1.5° C. or within a temperature range from as close to freezing as possible without freezing to about 3° C., and in an oxygenated environment. The cut of meat is held for a predetermined extended period of time for conditioning the cut of meat to increase shelf life before transferring to a retail display temperature.

Typically and preferably for beef, the time for conditioning the cut of meat is between about 7 hours and about 24 hours. However, in other circumstances the time will vary depending on factors such as the desired shelf life, meat, species, cut of meat and the like. For example, in the preferred form to best ensure the meat maintains a fresh and/or healthy appearance for as long as possible, the meat is conditioned for 24 hours or alternatively an optimal period of time whereby a depth of oxygenation of exposed cut surfaces of the meat is increased by at least about 50%.

In the preferred form it has been found that a longer conditioning time (of more than about 24 hours) does not generally improve the fresh and/or healthy appearance in beef and can allow oxidation reactions to accumulate. This would begin to reverse the advantages provided by the conditioning step as the cut of meat will begin to degrade. Conditioning time of less than about 5 to 7 hours can also reduce the time to which the fresh and/or healthy appearance is maintained in a retail display environment. In effect, insufficient conditioning time or excessive conditioning time subtracts from the retail display shelf life.

The applicant claims that the conditioning step described in relation to the preferred embodiment departs from the current teachings in the field. The prevailing view prior to this invention has been to have meat enter retail display as soon as possible after cutting.

The preferred oxygenated environment in which the cut of meat is stored during the conditioning step is at ambient levels. However, in one alternative embodiment of the invention an elevated oxygen containing atmosphere at up to about 100% oxygen may be used. Conditioning the cut of meat in an elevated oxygen containing atmosphere has been found to improve the extent and speed of oxygenation of exposed surfaces of the cut of meat. However, this adds to cost and complication. Lower levels of increased oxygen up to 80% from ambient are also acceptable.

Alternatively, an oxygenated environment of less than ambient levels of oxygen may be acceptable where delayed oxygenation penetration may be desirable. Again however, this can add complication and cost. Furthermore, conditioning levels of less than about 20% oxygen would be unlikely to result in a competitive system.

Following the conditioning step, the packaged meat may be displayed at retail display temperatures which are typically between 3° C. to 15° C., and more typically 5° C. to 10° C. The colour of the surface of meat is maintained in a desirable condition for an extended length of time, providing additional shelf life over traditional and prior art methodology. Typically shelf life may be extended by up to 7 days. Venison has been extended by 2 to 3 days and lamb by 5 to 7 days, for example. Of course, the extent of extended shelf life will in part depend on the meat conditioned and steps and conditions prior to cutting.

Additional steps may be incorporated into the preferred method above to further improve the fresh and/or healthy appearance of the meat.

In a second preferred embodiment of the invention, meat primals may be preconditioned prior to the cutting and the conditioning step outlined above to modify, improve or better control the quality, freshness and/or healthy appearance, shelf life or other characteristics of the meat at retail display.

Preconditioning preferably involves treatment of meat primals under positive pressure in a substantially oxygen-free environment while cooling and before cutting the meat primals into cuts of meat.

In this second preferred form, following slaughter and deboning, the meat primal is cooled, ideally to the temperature substantially as close to freezing as possible without freezing the meat primal. During this cooling phase, the meat is stored under positive pressure in a substantially oxygen-free environment.

It will be appreciated by those skilled in the art that storing meat primals in an oxygen-free environment can typically be achieved in a number of ways.

Meat primals can be stored in primal vacuum packs for example. The barrier material used for vacuum packaging is preferably designed to limit ingress of atmospheric oxygen. Some oxygen may diffuse through the bag. An acceptable vacuum packaging material will permit diffusion at a rate of about 20 ml/m²/24 hours.

A variation on the second preferred embodiment outlined above is to place the meat primals in a more strictly oxygen-free environment and mechanically restrict meat exudation or drip by positive pressure. Preferably mechanical compression of at least 3 psi directly immobilises most of the loosely held exudate within the meat primal, reducing the migration out of the meat as drip. Fluid retained within the meat primal is reabsorbed as it ages to increase meat fluid content and water-binding properties of the meat.

In this embodiment preconditioning may be achieved using the technology described in U.S. Pat. No. 6,194,012 and U.S. Pat. No. 5,670,195. An advantage of using the apparatus and method disclosed in these patent specifications is that natural antioxidants and metmyoglobin reductase in the meat primals are at least partially preserved or are less likely to degrade, leading to an improved raw material for conditioning according to this invention. Metmyoglobin reductase is the enzyme responsible for converting metmyoglobin back to myoglobin and it is therefore desirable to maintain the function of this enzyme for improved shelf life after conditioning.

The oxygen-free environment of the preconditioning step is maintained by the exclusion of gases and without the need for anoxic gases. Gases such as CO₂ and other inert gases can be used.

The meat primals, once cooled to about −1.5° C. (or within a temperature range as close to freezing as possible without freezing the meat) and aged, is removed from that environment and then undergoes cutting and other retail preparation before the conditioning step. Preferably retail preparation involving cutting takes place at between −1.5° C. and 10° C., and preferably 6° C. with the meat exposed for as short a time as possible.

The applicant's analysis is that the conditioning step suppresses oxygen consuming reactions (OCR) in the cut meat which impact on metmyoglobin reactions. The conditioning step delays the time when metmyoglobin becomes visible near or at the surface of the meat. In effect the conditioning step provides a method of stabilizing meat colour for an extended period of time over traditional times by suppressing the rate of myoglobin conversion to metmyoglobin or at least the visual effect of that conversion.

Meat being muscle tissue transformed into cuts of meat continues to carry out some chemical and/or enzymatic reactions which convert oxygen to water. This means that the meat “breathes”. When the exposed surface of the cut of meat is first exposed to oxygen either ambient or modified it will dissolve in the cut meat surface region and diffuse deeper in the meat. Because oxygen is consumed by the meat, a gradient of oxygen concentration forms in exposed or cut surface region, with the highest concentration at or adjacent the surface and with a gradual reducing oxygen concentration relative to depth, until a position is reached within the meat where the meat is completely anaerobic. This is because the diffusing oxygen is continuously consumed by the meat faster than it can diffuse inwards. The proportion of myoglobin that is bound to oxygen also forms a gradient.

The highest proportion of myoglobin in the bound state is at or immediately adjacent the cut and exposed surface. This proportion gradually decreases to zero in the anaerobic region. Oxidation of myoglobin to metmyoglobin also occurs in the meat. The rate of oxidation is fastest when only a proportion of the myoglobin is bound to oxygen and slowest when all the myoglobin is in the oxygen bound form. Within meat regions of low oxygenation interfacing with substantially anaerobic regions of the meat, oxymyoglobin concentrations are low, thus encouraging metmyoglobin formation. The metmyoglobin interface is generally visible on the surface of the meat when oxygen penetration of the exposed surface of the meat is low but is not visible when oxygen penetration is high.

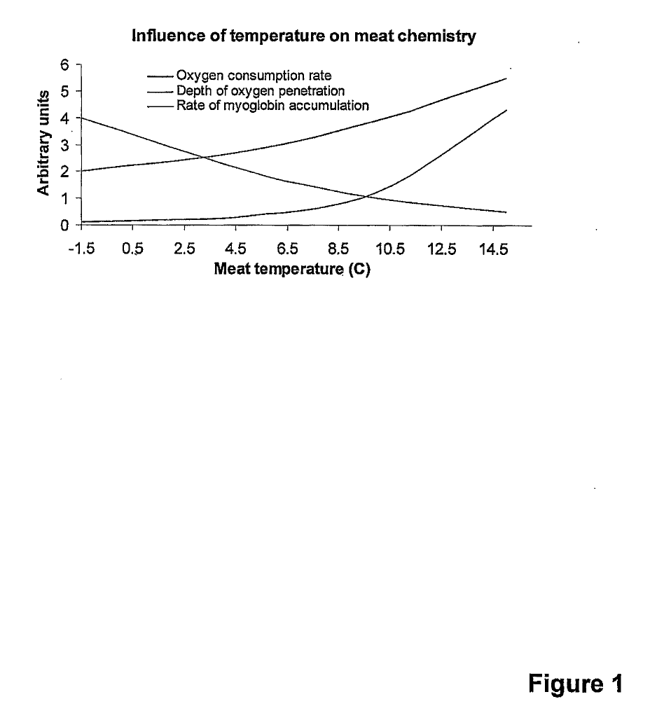

In addition, OCR in meat slows as temperature declines. This is best illustrated with reference to FIG. 1. A normal value for the temperature dependency of enzymatic reactions is about 40% between 5° C. to 0° C. (the temperature dependency of some enzymatic reactions can however be substantially greater than this). The OCR and rate of metmyoglobin accumulation are maximally reduced at about a temperature of −1.5° C. without damage to the meat through freezing.

When meat is conditioned as herein described at a temperature of about −1.5° C. following cutting, the applicant says three processes ensue:
1) OCR is suppressed by the low temperature, and conditioning at −1.5° C. plus or minus 3° C. allows the thickest possible layer of oxygenated meat tissue to develop on exposed surfaces of the cut of meat;
2) OCR further declines in the meat over the time within the oxygenated layer in response to exposure to oxygen (the conditioning effect); by the use of the low temperature, the conditioning effect occurs throughout the thickest possible layer of oxygenated meat; and
3) the use of a low conditioning temperatures ensures that myoglobin oxidation to metmyoglobin is minimized during the conditioning period.

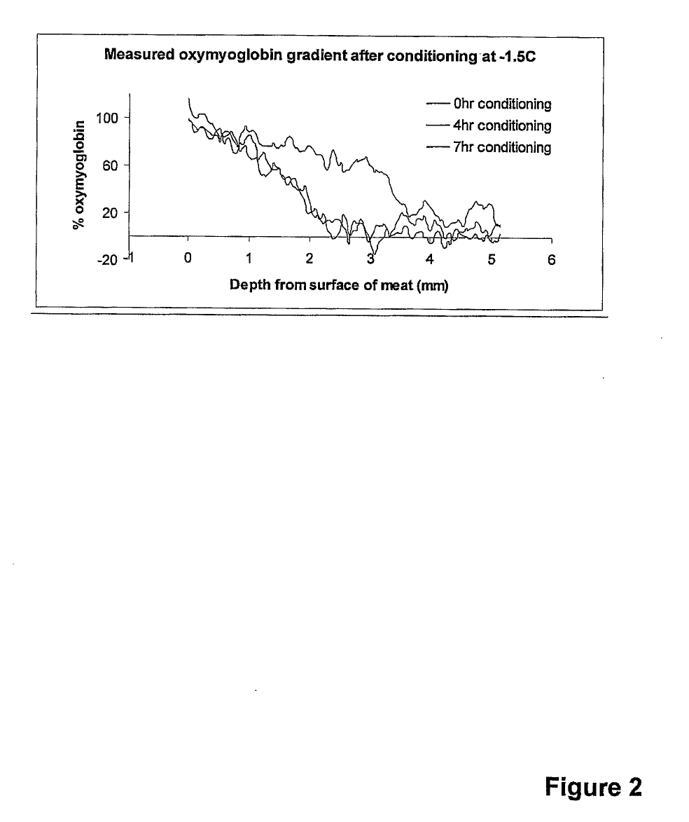

FIG. 2 illustrates measured oxymyoglobin levels relative to depth from the exposed surface of the meat. As can be seen in FIG. 2, cut meat which has been conditioned for 7 hours shows deeper penetration of oxymyoglobin and a layer of nearly 100% oxygenation reaching to 2 mm below the exposed surface of the cut meat. This indicates that the conditioning step has increased the level of oxymyoglobin within that region of the meat.

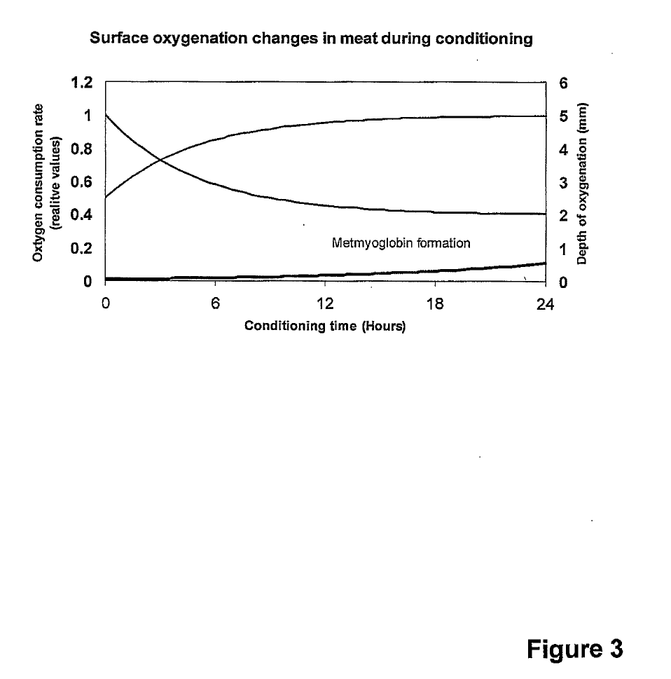

FIG. 3 illustrates that OCR continues to fall exponentially as the conditioning time increases from 0 hours to about 18 hours and this change is mirrored in the increased depth of oxygenation. After about 24 hours of conditioning, the OCR reaches a plateau and reduces only negligibly and oxygenation penetration of the meat reaches a plateau.

Preferably, the time predetermined to condition the meat is around time identified where the two curves reach a plateau, as shown in FIG. 3.

During the conditioning period, there is a slow accumulation of metmyoglobin, a process minimized by the use of a conditioning temperature as low as possible without freezing the meat. Conditioning beyond 24 hours provides minimal increases in oxygenation of the surface layer but subtracts from retail display life by allowing further metmyoglobin accumulation. Hence, the conditioning period is preferably limited to a maximum of 24 hours.

When the cut of meat temperature is increased to temperatures typically of 3° C. to 10° C. (for example, by transferring the product to retail display conditions/temperatures) after conditioning, the OCR will of course increase. However, as the exposed surfaces of the cuts of meat have been highly oxygenated by conditioning the increasing OCRs have less visible effect.

The increased temperature produces only a marginal change in appearance (bloom) as the degree of oxygenation remains high in the visible surface region.

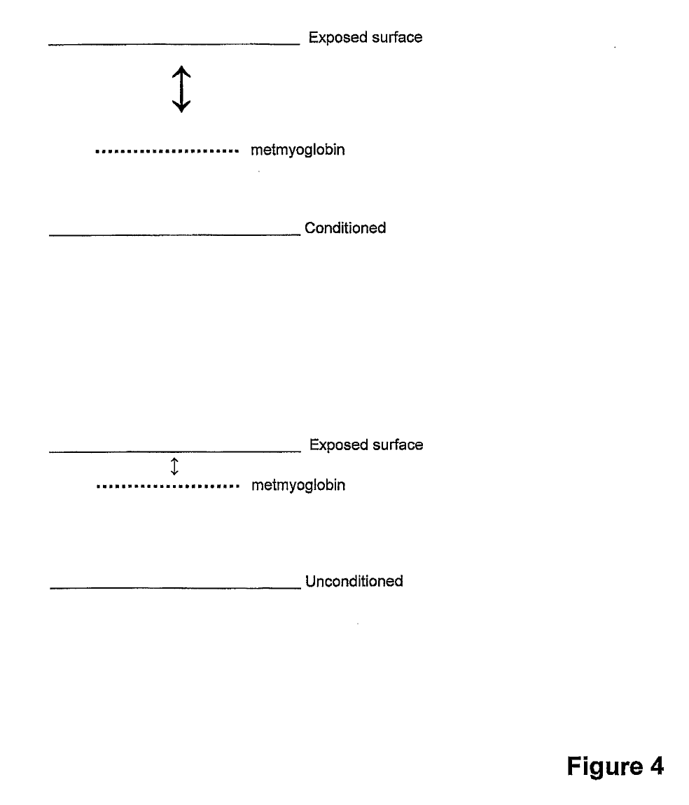

The resulting effect of this deep oxygenation of the surface region is to increase the time before the visible appearance of metmyoglobin conversion can be observed at or through the cut surface as shown in FIG. 4. For this reason, colour stability is maintained for longer.

Thus, by this invention, the cut of meat conditioned by the present invention has a longer potential shelf life than traditionally treated meat and enables retailers and users of the product to harness a delay in the time when metmyoglobin becomes visible through or on exposed surface regions of the meat as seen in FIG. 4. By reducing OCRs, whilst also minimising the accumulation of metmyoglobin, a stabilizing effect on the desired meat colour and appearance is provided, for a longer time than hitherto possible without resort to modified atmospheric packs and the like. In essence, the preferred process “primes” the cut of meat so that it is less sensitive to subsequent temperature changes when it is moved to retail display temperatures.

Current processes such as those involving CO atmosphere are attempts to extend the shelf life of meat, however the present invention provides a replicatable, reliable, natural process absent of disadvantages of the prior art.

The invention will now be described with reference to an Example.

### EXAMPLE 1

Retail display assessment tests were conducted comparing consumer acceptability of beef loin steaks prepared in a HiOx system with steaks conditioned by the conditioning step described herein.

The conditioned steaks were preconditioned as described herein by retaining in a CO₂ environment under positive pressure while cooling the meat to as close to freezing as possible without freezing the meat.

The preconditioning of the beef meat primals was performed using the technology discussed in U.S. Pat. No. 6,194,012 and U.S. Pat. No. 5,670,195.

The conditioning step was carried out for 12 hours following cutting of the meat into steaks and overwrapped on retail trays. The results of two trials are provided below (Tables 1 and 2).

The HiOx system consisted of 80% oxygen, 20% carbon dioxide.

TABLE 1
Consumer panel assessment of retail
display colour of loin steaks.^{1,2}

| | Day of Display | | | | | | |
|---|---|---|---|---|---|---|---|
| | 1 | 2 | 5 | 6 | 7 | 8 | 9 |
| Conditioned | 6.67 | 6.72 | 6.31 | 6.05 | 5.93 | 5.70 | 5.45 |
| HiOx | 6.55 | 6.59 | 6.37 | 6.01 | 5.88 | 5.98 | 5.50 |
| S.E.M.³ | 0.07 | 0.07 | 0.09 | 0.10 | 0.10 | 0.11 | 0.12 |

¹Key for colour assessment 8, extremely red; 7, very red; 6, moderately red; 5, slightly red; 4, slightly brown; 3, moderately brown; 2, very brown; 1, extremely brown.
²Means that have different superscripts in columns are significantly different (P < 0.05).
³S.E.M. = standard error of the mean assuming variances between treatments are equal.

TABLE 2
Consumer panel assessment of retail display
appearance of loin steaks.^{1,2}

| | Day of Display | | | | | | |
|---|---|---|---|---|---|---|---|
| Treatment | 1 | 2 | 5 | 6 | 7 | 8 | 9 |
| Conditioned | 7.39 | 7.39 | 6.69 | 6.04 | 5.67 | 5.36 | 5.32 |
| HiOx | 7.35 | 7.34 | 6.99 | 6.24 | 5.89 | 5.68 | 5.64 |
| S.E.M.³ | 0.12 | 0.11 | 0.12 | 0.13 | 0.14 | 0.15 | 0.17 |

¹Key for appearance assessment: 9, very good; 7, good; 5, average; 3, poor; 1, very poor.
²Means that have different superscripts in columns are significantly different (P < 0.05).
³S.E.M. = standard error of the mean assuming variances between treatments are equal.

After 9 days on display, the level of consumer satisfaction with conditioned meat compares favorably with prior art HiOx methods.

TABLE 3
Consumer panel assessment of retail display
purchase decision for loin steaks.^{1,2}

| | Day of Display | | | | | | |
|---|---|---|---|---|---|---|---|
| Treatment | 1 | 2 | 5 | 6 | 7 | 8 | 9 |
| FC ™ overwrap | 1.05 | 1.04 | 1.10 | 1.21 | 1.24 | 1.40 | 1.44 |
| HiOx | 1.05 | 1.02 | 1.07 | 1.16 | 1.23 | 1.31 | 1.34 |
| S.E.M.³ | 0.02 | 0.01 | 0.02 | 0.03 | 0.03 | 0.03 | 0.04 |

¹Key for purchase decision: 1, buy; 2, refuse to buy.
²Means that have different superscripts in columns are significantly different (P < 0.05).
³S.E.M. = standard error of the mean assuming variances between treatments are equal.

A level of consumer satisfaction of conditioned meat comparing favourably with current HiOx methods is achieved by the present invention.

Where in the foregoing description there has been made reference to specific components or integers of the invention having known equivalents then such equivalents are herein incorporated as if individually set forth.

Although this invention has been described by way of example only and with reference to preferred embodiments thereof, it is to be understood that modifications or improvements may be made without departing from the scope or spirit of the invention.

1-28. (canceled)

29. A method of maintaining a desirable fresh and/or healthy appearance of a cut of meat during retail display including the steps of:
controlling the temperature within a range sufficient to suppress oxygen consuming reactions and to effect the rate of myoglobin conversion to metmyoglobin, following cutting of said meat from a meat primal; and
maintaining said meat at said temperature in an oxygenated environment for a predetermined extended period of time before transfer to a retail display temperature.

30. A method according to claim 29, wherein said cutting includes exposing normally substantially anaerobic regions of said meat primal to an oxygenated environment to create said cut of meat having new surfaces which are exposed for the first time.

31. A method according to claim 29, wherein said meat is maintained at said temperature in an oxygenated environment immediately after cutting.

32. A method according to claim 29, wherein said oxygenated environment has an ambient or elevated oxygen level.

33. A method according to claim 29, wherein said predetermined extended period of time is selected to increase the depth and/or penetration of oxygenation of exposed surfaces of said meat.

34. A method according to claim 29, wherein said predetermined extended period of time is typically between about 7 hours to about 24 hours.

35. A method according to claim 29, wherein said temperature range is between about freezing point of said meat and about 3° C.

36. A method according to claim 29, wherein said meat is maintained at a temperature of substantially −1.8° C. to 3° C.

37. A method according to claim 36, wherein the meat is maintained at a temperature of about −1.5° C.

38. A method according to claim 29, wherein said meat primal is cooled before cutting.

39. A method according to claim 38, wherein said meat primal is stored in a cooled substantially oxygen-free environment prior to cutting.

40. A method according to claim 29, wherein said meat primal is stored under positive pressure prior to cutting.

41. A method according to claim 40, wherein said positive pressure is applied by a mechanical process exerting at least 3 psi directly to said meat primal.

42. According to a further aspect of this invention there is provided a method of maintaining a desirable fresh and/or healthy appearance of a cut of meat during retail display including the steps of:
preconditioning by storage of a meat primal under positive pressure in a substantially oxygen-free environment while cooling and before cutting into said cut of meat; and
conditioning said cut of meat following cutting by controlling the temperature within a range sufficient to suppress oxygen consuming reactions and to effect the rate of myoglobin conversion to metmyoglobin, in an oxygenated environment for a predetermined extended period of time before transfer to a retail display temperature.

43. A method according to claim 42, wherein said cutting includes exposing normally substantially anaerobic regions of said meat primal to an oxygenated environment to create said cut of meat having new surfaces which are exposed for the first time.

44. A method according to claim 42, wherein said cut of meat is maintained at said temperature in an oxygenated environment immediately following cutting.

45. A method according to claim 42, wherein said positive pressure is applied by a mechanical process exerting at least 3 psi directly to said meat primal.

46. A method according to claim 42, wherein said substantially oxygen-free environment is maintained by the exclusion of gases or without anoxic gases.

47. A method according to claim 42, wherein said predetermined extended period of time selected for conditioning is relative to a required depth and/or penetration oxygenation below exposed surfaces of said cut of meat.

48. A method according to claim 47, wherein said predetermined extended time period is within the range of 7 hours to 24 hours.

49. A method according to claim 42, wherein said temperature range is between the temperature as close to freezing of the meat without freezing said meat and 3° C.

50. A method according to claim 49, wherein said cut of meat is maintained at a temperature of substantially about −1.8° C. to 3° C.

51. A method according to claim 50, wherein the cut of meat is maintained at a temperature of about −1.5° C.

52. A method of stabilising meat colour in and below the surface of a cut of meat by suppressing myoglobin conversion to metmyoglobin at least on or immediately adjacent to the surface of said cut of meat, wherein the method includes the steps of claim 57.

53. A method of stabilising meat colour in and below the surface of a cut of meat by suppressing myoglobin conversion to metmyoglobin at least on or immediately adjacent to the surface of said cut of meat, wherein the method includes the steps of claim 42.

54. A method according to claim 52, wherein conversion is suppressed by suppressing oxygen consuming reactions in the meat, whilst said meat is exposed to an oxygenated environment.

55. A method according to claim 53, wherein conversion is suppressed by suppressing oxygen consuming reactions in the meat, whilst said meat is exposed to an oxygenated environment.

56. A meat product produced from the method of claim 57.

57. A meat product produced from the method of claim 42.

58. A method of maintaining a desirable fresh and/or healthy appearance of a cut of meat substantially as herein described with reference to any one of the accompanying Examples and/or Figures, excluding comparatives.

59. A meat product produced by the method of claim 58.
